(19) United States
(12) Patent Application Publication
(10) Pub. No.: US 2021/0201179 A1
(43) Pub. Date: Jul. 1, 2021

(54) METHOD AND SYSTEM FOR DESIGNING A PREDICTION MODEL

(71) Applicant: BULL SAS, Les Clayes-sous-Bois (FR)

(72) Inventors: Kaoutar SGHIOUER, Compiegne (FR); Mohamed HILIA, Boulogne Billancourt (FR)

(21) Appl. No.: 17/136,567

(22) Filed: Dec. 29, 2020

(30) Foreign Application Priority Data
Dec. 31, 2019 (FR) 1915811

(51) Int. Cl. G06N 5/04; G06N 20/00; G06F 16/901; G06Q 10/10; G06Q 10/06

(52) U.S. Cl. CPC G06N 5/04; G06N 20/00; G06Q 50/04; G06Q 10/101; G06Q 10/06395; G06F 16/901

(57) ABSTRACT

The invention relates to a method (1000) for designing a prediction model implemented by a computer system (1), said designing method (1000) comprising:
a step of transmitting (250,350,450) data to the analyst client and the business client,
a step of receiving (260, 360, 460) an instruction from each of the analyst client (20) and the business client (30) and in that a following step is initiated by the designer device (10) only if both instructions authorize said designer device (10) to do so.

The invention relates to the field of artificial intelligence, and more particularly to the use of learning algorithms for the design of prediction models. The invention relates to a method for designing a prediction model, said method being implemented by a computer system. The invention further relates to a computer system comprising a model designer device.

### PRIOR ART

Machine learning is now a democratized tool that has the capacity to reach all companies regardless of their field of activity.

Indeed, computer vision, natural language processing and the management of huge datasets enable machines to surpass humans in difficult tasks such as cancer diagnosis, infrastructure performance monitoring or intelligence. At the same time, equipment costs have decreased and implementation has become easier, allowing learning models to be used to improve human decision-making in all industries.

To achieve a high level of accuracy, analysts develop black-box learning models on large datasets that capture complex underlying relationships. While this process has been the norm for many years, concerns have arisen about the bias, safety, ethics and auditability of such models. This need is such that processes have even been developed to reconstruct the decision rules of a black box model (US20190147369).

In order to compensate for this lack of knowledge of the factors influencing a recommendation, methods are beginning to be developed that integrate business expertise to group model inputs into natural hierarchies. Nevertheless, these initiatives only allow a partial appreciation of the construction of the learning model and do not meet the need for transparency required for secure use of a learning model for decision support.

Indeed, for the predictions of an analysis model to be used in decision-making, users must be able to trust the learning model. To trust a model, they must understand how it makes its predictions, that is to say the model must be interpretable. Nevertheless, interpreting a prediction model is an extremely complex task. Indeed, prediction models can generally be based on dozens of parameters with complex underlying relationships.

Thus, there is a need for learning model design solutions for ensuring the foundation of a recommendation as well as the auditability and transparency of the operation of the machine learning system.

### Technical Problem

The invention therefore aims to overcome the disadvantages of the prior art. In particular, the invention aims at providing a method for designing a prediction model, wherein said method is fast, accurate and can be performed continuously. The present solution allows an easy and quick adaptation of the business knowledge in the developed algorithmic models. Moreover, it is particularly suitable for the monitoring of industrial processes and more particularly of information systems.

The invention further aims at providing a computer system for the design of prediction models built so as to offer a wide choice of algorithms and configured so as to ensure a facilitated and controlled verification of the relevance of the prediction model designed by a given analyst, by a business expert and possibly by a legal expert. Thus, the invention provides a computer system where ethical aspects can be taken into account from the design phases of predictive models.

### BRIEF DESCRIPTION OF THE INVENTION

For this purpose, the invention relates to a method for designing a prediction model implemented by a computer system, said computer system comprising: a model designer device, an analyst client, a business client;
said model designer device including a communication module, a data processing unit and a data memory;
said design method comprising:
   a step of receiving a business dataset by the communication module,
   a step of generating, by the processing unit, at least one optimized business dataset from the business dataset,
   a step of designing, by the processing unit, a plurality of variables from the business dataset,
   a step of generating, by the processing unit and from preselected learning models and the plurality of selected variables, at least one prediction model, and
   a step of evaluating, by the processing unit, the performance of the prediction model, said evaluation including calculating a prediction quality indicator;
said method being characterized in that for at least two steps selected from the generation, design and generation steps, the method further includes:
   a step of transmitting, by the communication module, data to the analyst client and the business client,
   a step of receiving, by the communication module, an instruction from each of the analyst client and the business client,
and in that a following step is initiated by the designer device only if both instructions authorize said designer device to do so.

The present solution allows an easy and quick adaptation of the business knowledge in the developed algorithmic models. In fact, faced with the democratization of artificial intelligence projects, it has been necessary to develop a solution allowing a quick understanding of the data, its value and the algorithmic result resulting from its consideration.

Thus, the present invention relates to a method or a system for designing a prediction model from the phase of cleaning a dataset to the phase of evaluating the proposed prediction model so as to make it intelligible to business users.

In particular, this solution integrates inputs from business “aspects” directly between each of the cleanup, exploratory, modeling or evaluation phases, and this, in order to generate a more efficient and faster prediction model for a given business domain.

This can for example be made possible by the production of an indicator (of performance, consistency, adaptation or business) and by the possibility to display and/or modify the prediction model in accordance with a business aspect.

The present invention provides a method and a computer structure for organizing the generation of the prediction model based on the contribution of a data analyst and then of a business expert at each of the major stages of development of a prediction model. The transition between the stages is made after validation of each of the stakeholders.

Thus, the present invention gives a 360° vision to the designer of the prediction model which will allow him/her to reach a result more quickly than with conventional methods and will also allow him/her to reach higher performance levels than with standard methods.

### According to Other Optional Features of the Method:

The preselected learning models are stored in a database used by the prediction model designer device. In particular, this database may include several dozen learning algorithms, preferably several hundred learning algorithms.
The method includes reverse engineering of an optimized dataset, reverse engineering of a plurality of variables or reverse engineering of a prediction model, depending on the data contained in the instruction of the business client and after validation by the analyst client.
The method includes reverse engineering of a prediction model depending on data generated in the evaluation step.
The method includes steps for generating graphical indicators for modeling the prediction models and the results associated with a business user, in order to facilitate the implementation of the prediction models. These indicators may include, among other things, distributions of variables, thresholds, extreme values or outliers for business experts who provide explanations, and the importance of these variables in the design of the predictive models.
The prediction quality indicator is measured after each of the generation, design and generation steps. In particular, the model is verified in the training phase by applying conventional methods of dividing the dataset into training and test data. This test data will be used to make a first selection of suitable models with the desired objective. Initially, standard models are used such as Random Forest, SVM, Regression, PCA.
the transmission step, by the communication module, also includes transmitting data to a controller client and in that a subsequent step is initiated by the designer device only if an instruction from the controller client authorizes said designer device to do so. Thus, it is possible to bring together many expertises in a prediction model design method. For example, the controller client may have predetermined rules for highlighting variables or relationships between variables that are contrary to the regulations (for example GDPR). Indeed, it is necessary to manage the data and their exploitation in compliance with the GDPR. In addition, the controller client may have predetermined rules for identifying data to be made anonymous or pseudonymous.
The method includes a step of transmitting outliers to the business client and receiving a status for each of the transmitted outliers. Indeed, the interpretation of outliers is of great importance and the suppression of some data wrongly considered as outliers can have a very negative impact on prediction performance. Indeed, once an outlier has been identified, it is necessary for a person skilled in the art to be able to give a meaning or validate its exclusion.
The method includes a step for imputing values for missing values in the dataset. In particular, these values are imputed by the business client. Here, the business role in this step is crucial, just as in the case of outliers.
the step of transmitting, by the communication module, data to the analyst client and the business client, includes transmitting data in the form of:
   clouds, such as point or word clouds,
   histograms, and/or
   tabular selections.
In particular, the method according to the invention may implement visual methods (partial dependence plots, individual conditional expectation, cumulative local effects), significance analysis of characteristics, substitution models, or the calculation of Shapley values.
the variables selected from the business dataset are each transmitted to the controller client and the controller client returns a relevance value for each of the selected variables. In particular, the controller client will be able to identify, based on predetermined rules, variables to be favored or, on the contrary, to be restricted.
the variables selected from the business dataset are each transmitted to the business client and the business client returns a relevance value for each of the selected variables.
the step of generating at least one prediction model includes generating several prediction models, preferably built via parallelization, and the generated prediction models being prioritized according to their performance. Indeed, it is particularly advantageous to preselect several models (built via parallelization) and to prioritize them with the calculation of several KPIs for each of them. In addition, each of the generated prediction models is associated with performance indicator values.
the business dataset includes data generated by industrial production sensors and the business dataset is used by a machine learning model trained for monitoring an industrial process.
the industrial production sensors include: connected objects, machine sensors, environmental sensors and/or computer probes.
the industrial process is selected from: an agri-food production process, a manufacturing production process, a chemical synthesis process, a packaging process or a process for monitoring an IT infrastructure.
industrial process monitoring corresponds to industrial process security monitoring and includes in particular predictive maintenance, failure detection, fraud detection, and/or cyber attack detection.
the business and/or controller client also transmit to the designer device instructions to change the hierarchy of the generated prediction models. Indeed, the business and legacy departments then have the possibility to adjust the ranking.
The method includes a step of generating a representation of the relationships between the variables used by a prediction model. Indeed, business and legacy may need to correct these relationships.
The method includes a step of memorizing each of the generated models with the instructions relating thereto as well as the performance indicator values associated therewith. Such a versioning of prediction models and HMI results allows in the long term a saving of human time and a reduction of the risk of errors.

Other implementations of this aspect include computer systems, apparatus and corresponding computer programs recorded on one or more computer storage devices, each configured to perform the actions of a method according to the invention. In particular, a system of one or more computers may be configured to perform particular operations or actions, especially a method according to the invention, by installing software, firmware, hardware or a combination of software, firmware or hardware installed on the system. In addition, one or more computer programs may be configured to perform particular operations or actions by means of instructions which, when executed by data processing equipment, cause the equipment to perform the actions.

The invention further relates to a computer system for designing a prediction model, said computer system comprising: a model designer device, an analyst client, a business client;
said model designer device including a communication module, a data processing unit and a data memory;
said computer system being configured to:
   receive a business dataset by the communication module,
   generate, by the processing unit, at least one optimized business dataset from the business dataset,
   design, by the processing unit, a plurality of variables from the business dataset,
   generate, by the processing unit and from preselected learning models and the plurality of selected variables, at least one prediction model, and
   evaluate, by the processing unit, the performance of the prediction model, said evaluation including calculating a prediction quality indicator;
said computer system being characterized in that for at least two steps selected from the generation, design and generation steps, the system further includes:
   transmitting, by the communication module, data to the analyst client and the business client,
   receiving, by the communication module, an instruction from each of the analyst client and the business client and in that a following step is initiated by the designer device only if both instructions authorize said designer device to do so.

The invention further relates to a computer program product comprising program instructions for implementing a method for designing a prediction model according to the invention.

Other advantages and features of the invention will appear upon reading the following description given by way of illustrative and non-limiting example, with reference to the appended figures:

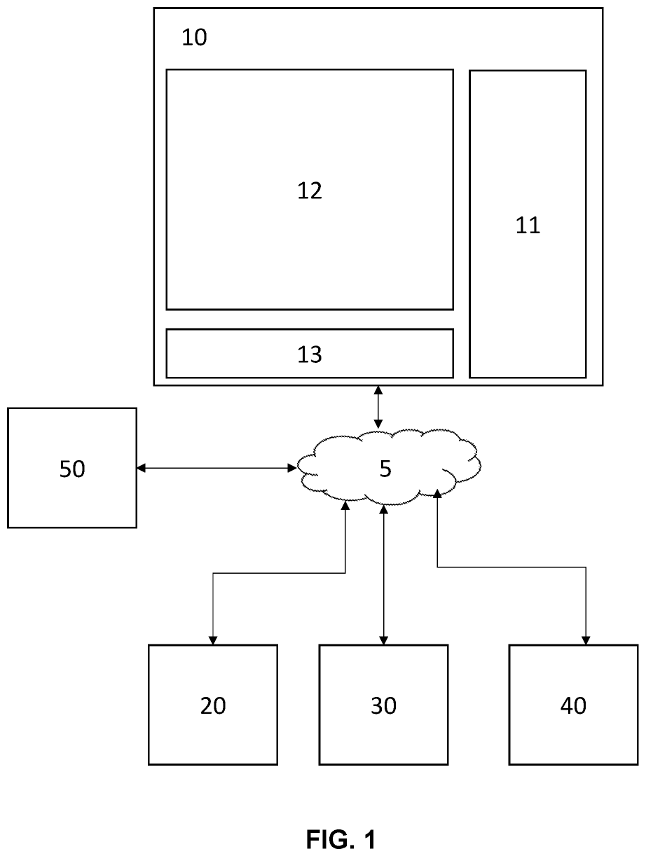

FIG. 1 shows a diagram of a computer system for designing prediction models according to the invention.

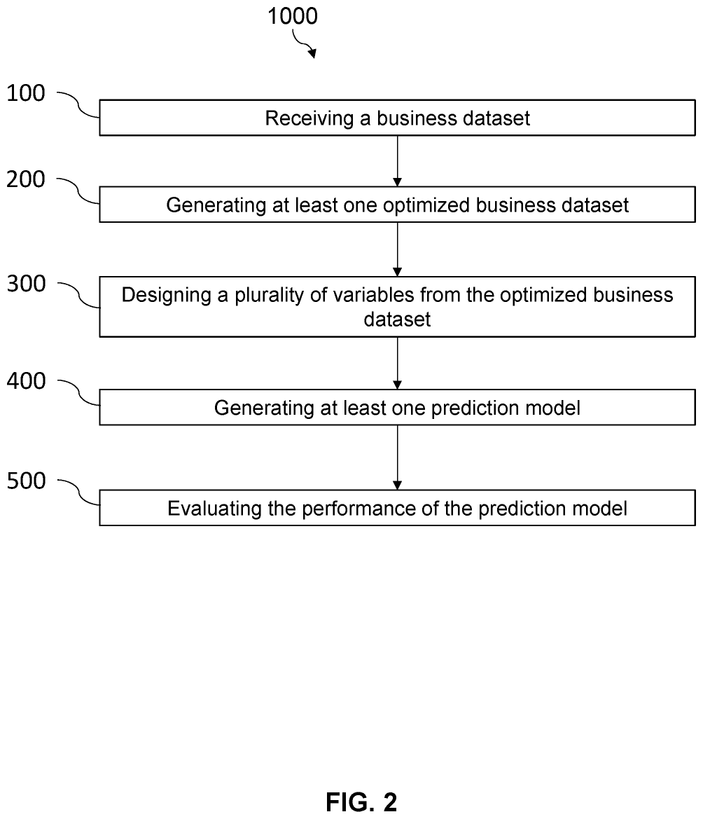

FIG. 2 shows a schematic illustration of a method for designing predictive models according to the invention.

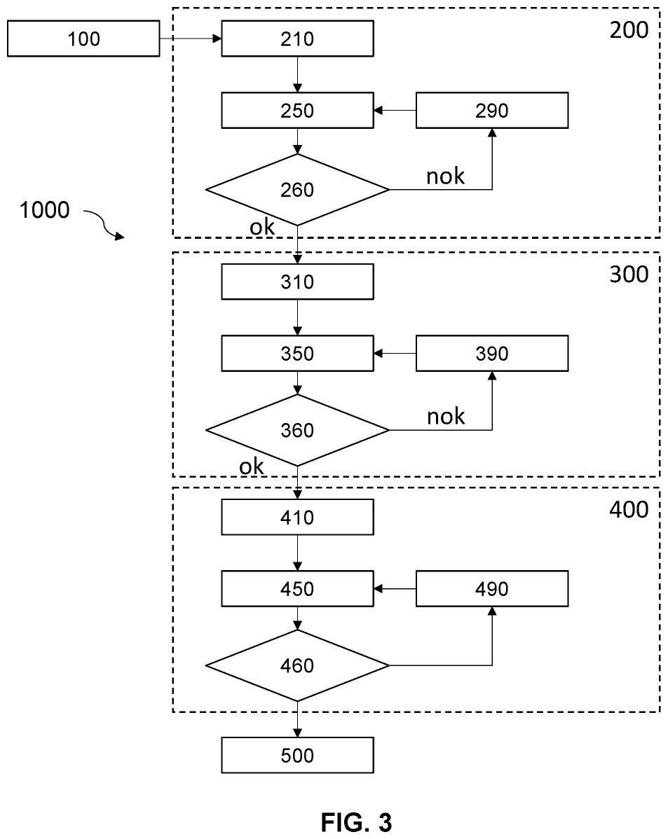

FIG. 3 shows a schematic representation of a method for designing predictive models according to an embodiment of the invention.

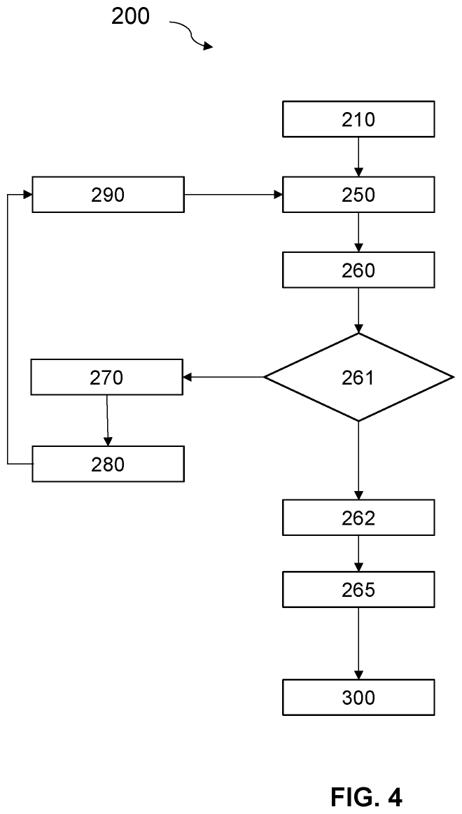

FIG. 4 shows a schematic illustration of a step of generating at least one optimized business dataset of a method for designing prediction models according to an embodiment of the invention.

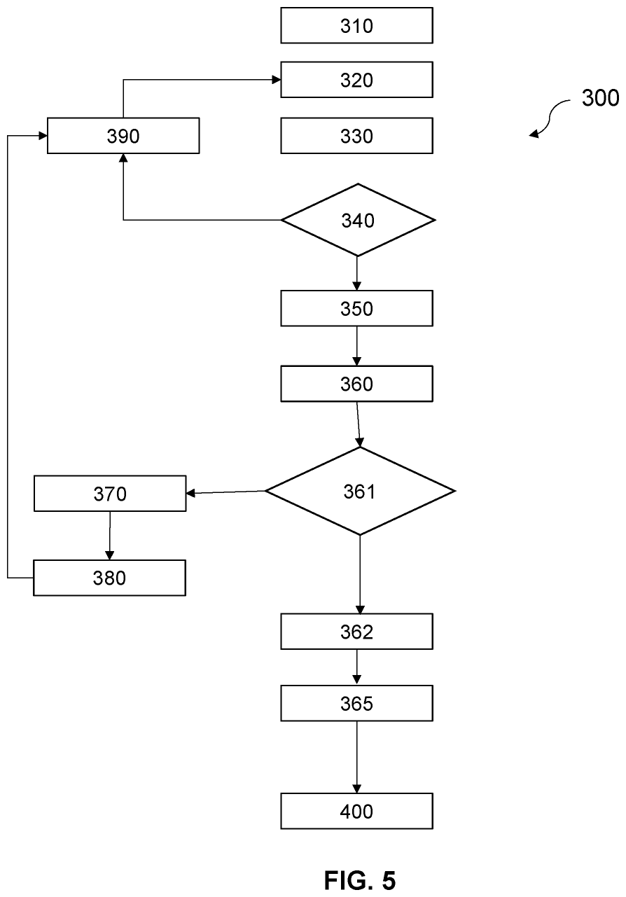

FIG. 5 shows a schematic illustration of a step of designing a plurality of variables from the optimized business dataset of a method for designing prediction models according to an embodiment of the invention.

Aspects of the present invention shall be described with reference to flowcharts and/or block diagrams of methods, apparatus (systems) and computer program products according to embodiments of the invention.

In the figures, the flowcharts and block diagrams illustrate the architecture, the functionality and the operation of possible implementations of systems, methods and computer program products according to various embodiments of the present invention. In this respect, each block in the flowcharts or block diagrams may represent a system, device, module or code, which comprises one or more executable instructions for implementing the one or more specified logical functions. In some implementations, the functions associated with the blocks may appear in a different order than shown in the figures. For example, two blocks shown in succession may, in fact, be executed substantially simultaneously, or the blocks may sometimes be executed in reverse order, depending on the functionality involved. Each block in the flow diagrams and/or flowchart, and combinations of blocks in the flow diagrams and/or flowchart, may be implemented by special hardware systems that perform the specified functions or acts or perform combinations of special hardware and computer instructions.

### DESCRIPTION OF THE INVENTION

The expression “analyst client”, “controller client” or “business client” corresponds to software, stored on a computer device, preferably different from the designer device according to the invention, for analyzing and processing a request to encode data.

The term “client-side” can refer to activities that can be performed on a client in a client-server network environment. Consequently, activities that can be performed “server-side” on a server in a client-server network environment can be specified.

The term “business dataset” refers to a collection of related data elements that are associated with each other and accessible individually or in combination, or managed as an entity. A business dataset is usually organized in a data structure. In a database, for example, a dataset may contain so-called “business” data (names, salaries, contact details, sales figures, etc.). The database itself can be considered a dataset, as can the bodies of data it contains that are associated with a specific type of information, for example, sales data from a corporate department.

The term “Data” refers to one or more files or parameter values. With parameter values being for use in high-performance computing solutions, generated by high-performance computing solutions or generated from data from high-performance computing solutions. The data within the meaning of the invention may in particular correspond to calculation input files that can be accessed and processed by several high-performance computing solutions, calculation results that can be accessed and processed by several high-performance computing solutions, data on the duration before completion of the calculations, values from energy consumption measurements, values from resource use measurements (network bandwidth, storage I/O, memory, CPU, GPU, etc.), billing information, system parameter values in particular of the systems implementing the high-performance computing solutions or even parameter values of the hardware infrastructure hosting the high-performance computing solutions.

The expression “outliers” corresponds to a value or observation that is “distant” from other observations of the same phenomenon, that is to say in sharp contrast to “normally” measured values. An outlier may be due to the inherent variability of the observed phenomenon or it may also indicate an experimental error, in which case the latter is often excluded from the dataset.

The term “learning”, within the meaning of the invention, corresponds to a method designed to define a function f allowing a value Y to be calculated from a base of n labeled (X1 . . . n, Y1 . . . n) or unlabeled (X1 . . . n) observations. Learning can be said to be supervised when it is based on labeled observations and unsupervised when it is based on unlabeled observations. In the context of the present invention, learning is advantageously used for calibrating the method and thus adapting it to a particular computing infrastructure.

The term “resource”, within the meaning of the invention, corresponds to parameters, capacities or functions of computing devices allowing the operation of a system or an application process. A same computing device is usually associated with several resources. Similarly, a same resource can be shared between several application processes. A resource is usually associated with a unique identifier that can be used to identify it within an IT infrastructure. For example, the term “resource” may include: network disks characterized by performance indicators such as, for example, by their inputs/outputs, reading/writing on disks, memories characterized by a performance indicator such as the usage rate, a network characterized by its bandwidth, a processor characterized for example by its usage (in percent) or the occupancy rate of its caches, a random access memory characterized by the quantity allocated. By “resource usage” is meant the consumption of a resource, for example by a business application.

By “computing device” is meant any computing device or computing infrastructure comprising one or more hardware and/or software resources configured to send and/or receive data streams and to process them. The computing device can be a computing server.

The expression “connected object”, within the meaning of the invention, corresponds to an electronic object connected, by a wired or wireless connection, to a data transport network, so that the connected object can share data with another connected object, a server, a fixed or mobile computer, an electronic tablet, a smartphone or any other connected device in a given network. In a manner known per se, such connected objects can be, for example, tablets, smart lighting devices, industrial tools or smartphones.

By “Data Providers” is meant any sensors (such as industrial production sensors), probes (such as computing probes) or computer programs capable of generating industrial process monitoring data. They can also correspond to computing devices such as servers that manage data generated by sensors, probes or computer programs.

By “prediction model” is meant any mathematical model for analyzing a volume of data and establishing relationships between factors for assessing risks or opportunities associated with a specific set of conditions, in order to guide decision-making towards a specific action.

The term “reverse engineering” corresponds to an action associated with a change after the analysis of a given result. For example, reverse engineering can be associated with a modification of a learning model type with respect to a particular dataset, after analysis of one or more performance indicators associated with said learning model.

The expression “transition to an anomaly”, within the meaning of the invention, may correspond to a moment when a metric or a plurality of metrics (related or not) present a risk or a result obtained by computing, of exceeding a predetermined threshold or indicative of a risk of failure or technical incident on the IT infrastructure.

The expression “technical incident” or the term “failure”, within the meaning of the invention, corresponds to a slowdown or shutdown of at least part of the IT infrastructure and its applications.

A technical incident can be caused by a network error, a process failure or a failure of part of the system.

The expression “computing infrastructure”, within the meaning of the invention, corresponds to a set of computing structures (that is to say computing devices) capable of running an application or an application chain. The IT infrastructure can be one or more servers, computers, or include industrial controllers. Thus, the IT infrastructure may correspond to a set of elements including a processor, a communication interface and memory.

By “probe” or “computing probe” is meant, within the meaning of the invention, a device, software or process associated with equipment which makes it possible to carry out, manage and/or feed back to computer equipment measurements of the values of performance indicators such as system parameters. This can be broadly defined as resource usage values, application runtime parameter values, or resource operating state values. A probe according to the invention therefore also encompasses software or processes capable of generating application logs or event histories (“log file” in Anglo-Saxon terminology). In addition, probes can also be physical sensors such as temperature, humidity, water leakage, power consumption, motion, air conditioning, and smoke sensors.

The expression “performance indicator” or “metric” referred to by the acronym “KPI” in the following description, within the meaning of the invention, corresponds to a value derived from a calculation method associated with a given test. The purpose of such a value is to characterize the performance of a learning model for a particular dataset. Thus, a plurality of KPIs can be produced using various tests depending on the problem to be studied (classification, regression, ranking or “ranking”, clustering, cross-validation, etc.).

The expression “performance indicator value” or “metric value”, within the meaning of the invention, corresponds to a measurement or calculation value of a technical or functional property of one or more elements of an IT infrastructure representing the operating state of said IT infrastructure.

By “process”, “calculate”, “run”, “determine”, “display”, “extract”, “compare” or more broadly an “executable operation” is meant, within the meaning of the invention, an action performed by a device or a processor unless the context indicates otherwise. In this respect, operations refer to actions and/or processes in a data processing system, such as a computer system or electronic computing device, which manipulates and transforms data represented as physical (electronic) quantities in the memories of the computer system or other devices for storing, transmitting or displaying information. These operations may be based on applications or software.

The terms or expressions “application”, “software”, “program code”, and “executable code” mean any expression, code or notation, of a set of instructions intended to cause a data processing to perform a particular function directly or indirectly (for example after a conversion operation into another code). Exemplary program codes may include, but are not limited to, a subprogram, a function, an executable application, a source code, an object code, a library and/or any other sequence of instructions designed for being performed on a computer system.

By “processor” is meant, within the meaning of the invention, at least one hardware circuit configured to perform operations according to instructions contained in a code. The hardware circuit may be an integrated circuit. Examples of a processor include, but are not limited to, a central processing unit, a graphics processor, an application-specific integrated circuit (ASIC), and a programmable logic circuit.

By “coupled” is meant, within the meaning of the invention, connected, directly or indirectly, with one or more intermediate elements. Two elements may be coupled mechanically, electrically or linked by a communication channel.

The expression “human-machine interface”, within the meaning of the invention, corresponds to any element allowing a human being to communicate with a computer, in particular and without that list being exhaustive, a keyboard and means allowing in response to the commands entered on the keyboard to perform displays and optionally to select with the mouse or a touchpad items displayed on the screen. Another embodiment is a touch screen for selecting directly on the screen the elements touched by the finger or an object and optionally with the possibility of displaying a virtual keyboard.

By “database” is meant a collection of data recorded on a computer-accessible medium and organized in such a way that it can be easily accessed, administered and updated. A database according to the invention may comprise different types of content in the form of text, images or numbers and can thus correspond to any known type of database such as, in particular, a relational database, a distributed database or an object database. Communication with such a database is ensured by a set of programs that make up the database management system operating in client/server mode, the server receives and analyzes requests issued by the client in SQL, for “structured language query” according to Anglo-Saxon terminology, format, adapted to communicate with a database.

The term “correlation” within the meaning of the invention corresponds to a statistical relationship, causal or not, between two variables or the values of two variables. In the broadest sense, any statistical association is a correlation, but this term refers, for example, to the closeness between two variables and the establishment of an order relationship. The term “causal” or “causality” within the meaning of the invention corresponds to a causal statistical relationship between two variables or the values of two variables. In particular, one of the variables is a cause that is wholly or partially responsible for the value of the other variable through an effect. The value of the first variable can for example be considered as a cause of a value (current or future) of the second variable. Whether for correlation or causality, one or more variables may have a statistical relationship with one or more other variables. Furthermore, an indirect correlation or causality within the meaning of the invention corresponds to the existence of a causality or correlation link chain between a first variable and another variable. For example, a first variable is correlated with a second variable which is itself correlated with a third variable which is finally correlated with another variable.

The term “plurality” within the meaning of the invention corresponds to at least two. Preferably it corresponds to at least three, more preferably at least five and even more preferably at least ten.

By “predetermined threshold” is meant, within the meaning of the invention, a maximum value of a parameter, an indicator or a variable. These limits may be real or hypothetical and generally correspond to a level beyond which a decline in performance may occur.

By “variable” is meant, within the meaning of the invention, a characteristic of a statistical unit which is observed and for which a numerical value or a category of a classification can be assigned.

By “selection techniques” is meant, within the meaning of the invention, a finite sequence of operations or instructions allowing a value to be calculated via statistical tests such as the ANOVA test, the test of mutual information between two random variables, the Chit test, regression tests (for example linear regression, mutual information), SVM, or recursive elimination, and allowing a set comprising relevant variables, in particular the best or most relevant variables, to be obtained.

In the following description, the same references are used to designate the same elements.

As mentioned, machine learning is a major part of the fourth industrial revolution. Thus, industrial processes are more and more frequently improved through the integration of artificial intelligence or, more specifically, machine learning models capable of addressing technical problems as varied as there are industrial processes.

In particular, machine learning is based on a multitude of data that can come from several different sources and can therefore be highly heterogeneous. Thus, with the methods of the prior art, it is common for a team of data scientists to be trained in data processing and set up data processing processes. Nevertheless, when data sources are diverse and vary over time, the prior art methods are not reactive and can cause shutdowns of industrial processes. Indeed, when machine learning is used for industrial process control, a non-adapted preprocessing of this multitude of data sources can lead to a decrease in the responsiveness of control processes or worse a lack of sensitivity.

In addition, there are already many solutions for designing prediction models. Nevertheless, most of these solutions lead to the design of black boxes or do not allow a strict framework for a multidisciplinary design of a prediction model.

The inventors therefore provided a method and a device for designing a prediction model that would make it possible to supervise the co-construction of such a model and establish strict milestones preventing the construction of a model that has not been validated by all stakeholders. Indeed, collaborative solutions today are permissive and can lead to the creation of non-optimal or worse unethical prediction models in the absence of careful attention from stakeholders.

For this purpose, the applicant provides a method and a device for controlling a majority of the key steps in the design of a prediction model.

The invention therefore relates to a method 1000 for designing a prediction model.

In particular, as illustrated in FIG. 1 and as will be described later, the method for designing a prediction model can be implemented by a computer system 1.

Preferably, it can be implemented by a model designer device 10 configured to operate within a computer system 1 that may include clients and databases 50. The designer device can be a computer model designer device.

The model designer device 10 includes a communication module 11, a data processing unit 12 and a data memory 13.

In particular, the model designer device 10 comprises a data processing unit 12. The model designer device 10, more particularly the data processing unit 12, is advantageously configured to carry out a method according to the invention. Thus, the data processing unit 12 can correspond to any hardware and software arrangement capable of executing instructions.

In particular, the model designer device 10 comprises a data memory 13. It is the data memory which will be able to store the instructions enabling the data processing unit to carry out a method according to the present invention.

The data memory 13 may include any computer-readable medium known in the art, including, for example, volatile memory, such as static random access memory (SRAM) and dynamic random access memory (DRAM), and/or non-volatile memory, such as read-only memory, flash memories, hard disks, optical discs and magnetic tapes. The data memory 13 may include a plurality of instructions or modules or applications to perform various functions. Thus, the data memory 13 can implement routines, programs, or matrix-type data structures. Preferably, the data memory 13 may include a medium readable by a computer system in the form of volatile memory, such as random access memory (RAM) and/or cache memory. The data memory 13, like the other elements, can for example be connected with the other components of the device 10 via a communication bus and one or more data carrier interfaces.

In particular, the data memory 13 may include a repository of learning models. This repository of learning models could correspond to a plurality of prediction models that have been previously generated (for example via supervised learning techniques) each of which could, for example, correspond to a business logic. Alternatively, this repository of learning models can be stored on a medium external to the designer device 10 but will be accessible for example via the network 5.

In particular, the model designer device 10 is configured to operate within a computer system 1 that may include clients and databases 50. Thus, the computer device 10 may also include a communication module 11.

A communication module 11 according to the invention is in particular configured to exchange data with third-party devices. The computer designer device 10 communicates with other computer devices or systems including clients 20, 30, 40 using this communication module 11. The communication module further allows to transmit the data on at least one communication network and may comprise a wired or wireless communication. Preferably, the communication is operated via a wireless protocol such as Wi-Fi, 3G, 4G, and/or Bluetooth. These data exchanges may take the form of sending and receiving files. In particular, the communication module 11 can be configured to allow communication with a remote terminal, including a client 20, 30, 40. A client is generally any hardware and/or software capable of communicating with a device according to the invention.

Thus, the device 10 according to the invention can carry out the invention in interaction with clients 20, 30, 40. In particular, these clients may correspond to the analyst, business and controller clients.

In addition, the communication module 11 can be configured in particular to allow communication with a database for example stored on a computer server and accessible by the designer device. The different modules or repositories are separate in FIG. 1, but the invention may provide for different types of arrangements, such as a single module combining all the functions described here. Similarly, these means can be divided into several electronic boards or gathered on a single electronic board. In addition, the designer computer device 10 and the analyst client may be the same device, but preferably the designer device is a computer server to which the clients 20, 30, 40 described in the present patent application can be connected.

A device 10 according to the invention may be integrated into a computer system and thus be capable of communicating with one or more external devices such as a keyboard, a pointing device, a display, or any device allowing a user to interact with the device 10. It should be understood that although not shown, other hardware and/or software components could be used together with a device 10. Thus, in an embodiment of the present invention, the device 10 can be coupled to a human-machine interface (HMI). The HMI, as already discussed, can be used to allow the transmission of parameters to the devices or conversely to make available to the user the values of the data measured or calculated by the device. In general, the HMI is communicatively coupled with a processor and comprises a user output interface and a user input interface. The user output interface can include a display and audio output interface and various indicators such as visual indicators, audible indicators and haptic indicators. The user input interface may include a keyboard, mouse or other cursor navigation module such as a touch screen, touchpad, stylus input interface and microphone for the input of audible signals such as user speech, data and commands that can be recognized by the processor.

As illustrated in FIG. 2, a method 1000 for designing a prediction model according to the invention includes the steps of receiving 100 a business dataset, generating 200 at least one optimized business dataset, designing 300 a plurality of variables from the optimized business dataset, generating 400 at least one prediction model, and evaluating 500 the performance of the prediction model.

Thus, a method 1000 for designing a prediction model according to the present invention includes a step of receiving 100 a business dataset.

The reception of a business dataset, in particular by the model designer device 10 can be done through a communication module 11.

The business dataset can come from many different sources and have different formats or layouts.

The invention can be applied regardless of the business data to be processed. For example, it could correspond to sensor data from measurements made in buildings, on computer or motorized devices, or on robotic devices. The data may also correspond to processed data resulting from calculations carried out by third party computer devices.

A method 1000 for designing a prediction model according to the present invention further includes a step of generating 200 at least one optimized business dataset. This generation step is detailed in FIG. 3 and FIG. 4.

The generation of at least one optimized business dataset is in particular carried out by the model designer device 10 in particular according to instructions stored in the data memory 13 and executed by the processing unit 12.

As illustrated in FIG. 3, a method 1000 for designing a prediction model according to the invention may include the steps of generating 210 first processed data, transmitting 250 the first processed data, receiving 260 an instruction from each of the analyst client 20 and the business client 30, and generating 290 new processed data.

Thus, with reference to FIG. 3, the design method according to the invention will include, after receiving a dataset, a step of generating 210 first processed data. This data will preferably be automatically processed by the predetermined transformation application stored in the data memory and applied by the processing unit.

These transformations could for example include: normalization, resampling, in particular candidate sampling, data aggregation, binning or bucketing and/or recoding of variables.

In addition, the method may include a step of detecting outliers in the dataset by comparison with predetermined functions. In particular, the method may include a step of calculating a correlation value between datasets and probability laws. This calculation step can be implemented, for example, by running programs or suitability measurement algorithms.

In addition, it may include an interpolation step for the completion of the missing data taking into account the consistency of the data with predefined correlation tables,

This first processed data is then transmitted by the communication module 11 to the analyst client 20 and to the business client 30. It can also be transmitted to the controller client 40.

The designer device is then configured to receive 260, for example via the communication module 11, one instruction from each of the analyst client 20 and the business client 30. As shown in FIG. 4, the designer device will further process these instructions to determine 261 whether the analyst client 20 and the business client 30 authorize the designer device to initiate the step 300 of designing a plurality of variables from the optimized business dataset.

In particular, the instruction may include an authorization token that will be verified by the designer device before the initiation “ok” of the subsequent steps. A method integrating an identification or authentication element makes it possible to bring robustness to the system and to certify that a model resulting from such a method will have been validated by a business client and possibly a controller client. In prior art systems, it is not possible to trace the validations nor to certify them making the prediction models generated uncertain, whereas with the present invention, the mechanisms in place make it possible to guarantee the traceability of the various operations carried out.

If the instruction does not include validation, for example the authorization token is absent or not verified, then the subsequent steps cannot be initiated “nok” and the design method according to the invention may include a step of generating 290 new processed data or reverse engineering.

In particular, if authorization is not obtained, at least one of the instructions received may include data and in particular proposals for changes to the first data processed. For example, the business client 30 may have given instructions to delete or complete some data.

In addition, the method may include a step 270 of transmitting instructions received by a given client to the other clients. This can allow verification of changes by the one or more other clients and thus improve the collaborative design of the prediction model.

In particular, the designer device may receive instructions to delete data from, for example, the controller client. Such a possibility makes it possible to quickly clean up a dataset so that it remains in compliance with current regulations and/or its execution allows the production of ethical predictions.

Thus, the design method according to the invention may include a step of analyzing 280 the instructions transmitted so as to extract data to be used in a step of generating new processed data.

Thus, the step of generating 290 new processed data, or reverse engineering, can advantageously rely on data transmitted in particular by the business client.

Advantageously, the method according to the invention may further include a step of determining 262 the quality of the data of the dataset, including the calculation 256 of a quality indicator. This may correspond to verification of the adequacy of probability laws to the data.

Preferably, the method according to the invention includes verifying the following laws of probability to the data:
Symmetrical continuous laws: Normal, Logistics, Cauchy, Uniform;
Asymmetrical continuous laws: Exponential, LogNormal, Gamma, Weibull;
Discreet law: Poisson.

For this purpose, a score is calculated between the data and the laws studied. Preferably, a score is calculated to determine the adequacy of the datasets to these different laws by means of a square test, in an automated/systematized mode:
Anderson-Darling test;
Cramer Von Mises test;
Kolmogorov-Smirnov test;
Chi² test.

For example, a method according to the invention may include implementing several univariate analyses, each of the univariate analyses aiming to study each of the variables independently. Preferably, the results of the univariate analysis are used to generate a quality indicator value.

As already mentioned, the method according to the invention may include a bivariate analysis which advantageously includes a step of calculating a correlation value between two variables.

In addition, other steps can be carried out and consist of imputing the missing values and selecting an imputation algorithm that will be validated by a “business” client. Thus, the method according to the invention may include a step of identifying a variable including missing data, selecting at least two imputation algorithms, calculating missing values from said algorithms and transmitting the calculated missing values to a “business” client. The method then includes selecting an imputation algorithm depending on a message sent by the “business” client. Preferably, only an imputation algorithm validated by a “business” client can be used to complete the missing values of a variable.

A method 1000 for designing a prediction model according to the present invention includes a step of designing 300 a plurality of variables from the optimized business dataset. This generation step is detailed in FIG. 3 and FIG. 5.

The generation of at least one optimized business dataset is in particular carried out by the model designer device 10 in particular according to instructions stored in the data memory 13 and executed by the processing unit 12.

As illustrated in FIG. 3, a method 1000 for designing a prediction model according to the invention may include the steps of generating 310 a first set of variables, transmitting 350 the first set of variables, receiving 360 an instruction from each of the analyst client 20 and the business client 30, and generating 390 a new set of variables.

Thus, with reference to FIG. 3, the design method according to the invention will include, after receiving a dataset, a step of generating 310 a first set of variables. This first set of variables is preferably generated automatically by the application of predetermined selection algorithms stored in the data memory and applied by the processing unit.

This selection may, for example, include running statistical tests such as: ANOVA, Test of mutual information between two random variables, Chit test, Regression tests (for example linear regression, mutual information), SVM (in English “support vector machine”), genetic algorithms or recursive elimination. This selection is configured to automatically result in a set comprising relevant variables, including the best or most relevant variables. Alternatively, this selection can be a random selection.

As shown in FIG. 5, the generation 310 of a first set of variables can be followed by the calculation 320 of a performance value for each of the variables of said first set. In addition, the method may be followed by the calculation 330 of a performance value for the set of variables. This automatically provides a value that can be used when checking the relevance of identified variables. Thus, the designer device according to the invention is configured to quantify the relevance of the selected variables.

In addition, it is preferably configured to establish a comparison 340 of the variable performance value to a predetermined threshold value. Thus, the design method according to the invention will be able to automatically discard a set of variables and reset a step of generating 390 a new set of variables, or reverse engineering. Similarly, the method may include a step of removing the variables from a generated variable subset when the variables are redundant. For example, when the correlation value between two variables exceeds a predetermined threshold, these variables could be automatically classified as probably redundant. They may then be sent automatically to the analyst client, who will have to confirm whether these variables are redundant.

The set of variables is then transmitted 350 by the communication module 11 to the analyst client 20 and to the business client 30. It can also be transmitted to the controller client 40.

The designer device 10 is then configured to receive 360, for example via the communication module 11, one instruction from each of the analyst client 20 and the business client 30. As shown in FIG. 5, the designer device will further process these instructions to determine 361 whether the analyst client 20 and the business client 30 authorize the designer device 10 to initiate the step 400 of generating at least one prediction model from the plurality of variables.

In particular, the instruction may include an authorization token that will be verified by the designer device before the initiation “ok” of the subsequent steps.

If the instruction does not include validation, for example the authorization token is absent or not verified, then the subsequent steps cannot be initiated “nok” and the design method according to the invention may include a step of generating 390 a new set of variables, or reverse engineering.

In particular, if authorization is not obtained, at least one of the instructions received may include data and in particular proposals for changes to the performance values assigned to the variables. For example, the business client 30 may have transmitted 362 instructions to change one or more performance values. Indeed, depending on the business knowledge, an expert may be able to modify 365 the weight to be given to each of the variables that will be used in the construction step of a learning model. It may, for example, increase or decrease the performance value assigned to a variable.

In addition, the method may include a step 370 of transmitting instructions received by a given client to the other clients. This can allow verification of changes by the one or more other clients and thus improve the collaborative design of the prediction model.

In particular, the designer device may receive instructions to delete variables, for example, from the controller client. Such a possibility makes it possible to quickly delete a variable, the use of which in a prediction game could violate current regulations and/or lead to ethical issues.

Thus, the design method according to the invention may include a step of analyzing 380 the instructions transmitted so as to extract data therefrom, such as performance values, to be used during a step of generating 390 a new set of variables. Thus, the step of generating 390 a new set of variables can advantageously rely on data transmitted in particular by the business client.

In particular, there will be a step of generating a new subset of variables when the performance value of the selected variable is below a predetermined threshold value. Similarly, there will be a step of generating a new subset of variables when the performance value of the selected subset, after modification of the performance values according to client instructions, is below a predetermined threshold value.

In this step, it is understood that the method will be able to run known methods for studying the different variables of the optimized dataset in order to select sets of variables that together will be able to predict certain events/behaviors.

For each of the variables, a weight will be calculated by the method and an overall weight (relevance) of the set of variables will be calculated.

The sets of variables will then typically be sent to the analyst client but also to a business client and a controller client.

The latter two may modify the “weights” or relevance values that have been calculated so as to indicate whether it is worth taking into account each of the variables to a greater or lesser extent. Using this new input data, the method will recalculate sets of variables and “weights” that will be submitted again to the business and “legal” specialists. This until validation of both clients is reached.

A method 1000 for designing a prediction model according to the present invention includes a step of generating 400 at least one prediction model. This generation step is detailed in FIG. 3.

The generation 400 of at least one prediction model in particular carried out by the model designer device 10 in particular according to instructions stored in the data memory 13 and executed by the processing unit 12.

As illustrated in FIG. 3, a method 1000 for designing a prediction model according to the invention may include the steps of generating 410 a plurality of prediction models, transmitting 450 performance data of the generated prediction models, receiving 460 an instruction from each of the analyst client 20 and the business client 30, and generating 490 a plurality of new prediction models.

Referring back to FIG. 2 or FIG. 3, a method 1000 for designing a prediction model according to the present invention also includes a step of evaluating 500 the performance of the prediction model.

In particular, the evaluation is carried out by the model designer device 10 in accordance with instructions stored in the data memory 13 and executed by the processing unit 12.

In particular, the evaluation step may involve cross-validations with, for example, the implementation of methods such as “Leave-One-Out Cross-Validation” in Anglo-Saxon terminology or “K-Fold”.

The evaluation step may also include regression analyses using, for example, methods such as absolute mean deviation or root mean square error (RMSE).

The evaluation step can also conventionally include a calculation of the coefficient of determination R².

1. A method for designing a prediction model implemented by a computer system, said computer system comprising: a model designer device, an analyst client, a business client;
said model designer device including a communication module, a data processing unit and a data memory;
said designing method comprising:
(a) receiving a business dataset by the communication module,
(b) generating, by the processing unit, at least one optimized business dataset from the business dataset,
(c) designing, by the processing unit, a plurality of variables from the business dataset,
(d) generating, by the processing unit and from preselected learning models and the plurality of variables, at least one prediction model, and
(e) evaluating by the processing unit, performance of the prediction model, said evaluation including calculating a prediction quality indicator; wherein for at least two steps selected from steps (b), (c) and (d), the method further includes:
transmitting, by the communication module, data to the analyst client and to the business client,
receiving, by the communication module, an instruction from each of the analyst client and the business client, and
a following step initiated by the designer device only if both said instructions authorize said designer device to do so.

2. The method for designing a prediction model according to claim 1, wherein preselected learning models are stored in a database used by the model designer device.

3. The method for designing a prediction model according to claim 1, further comprising reverse engineering of an optimized dataset, reverse engineering of a plurality of variables or reverse engineering of a prediction model, depending on the data contained in the instruction of the business client and after validation by the analyst client.

4. The method for designing a prediction model according to claim 1, further comprising generating graphical indicators for modeling the prediction models and their associated results, to a business user, in order to boost implementation of the prediction models.

5. The method for designing a prediction model according to claim 1, wherein the prediction quality indicator is measured after each of steps (b), (c) and (d).

6. The method for designing a prediction model according to claim 1, wherein the transmission step, by the communication module, also includes transmitting data to a controller client and a subsequent step is initiated by the designer device only if an instruction from the controller client authorizes said designer device to do so.

7. The method for designing a prediction model according to claim 1, further comprising transmitting outliers to the business client and receiving a status for each of the transmitted outliers.

8. The method for designing a prediction model according to claim 6, wherein variables selected from the business dataset are each transmitted to the controller client and the controller client returns a relevance value for each of the selected variables.

9. The method for designing a prediction model according to claim 7, wherein variables selected from the business dataset are each transmitted to the controller client and the controller client returns a relevance value for each of the selected variables.

10. The method for designing a prediction model according to claim 1, wherein variables selected from the business dataset are each transmitted to the business client and the business client returns a relevance value for each of the selected variables.

11. The method for designing a prediction model according to claim 1, wherein the step (d) includes generating several prediction models, built via parallelization, the generated prediction models being prioritized according to their performance.

12. The method for designing a prediction model according to claim 1, wherein the business client further transmits to the designer device instructions for changing a hierarchy of the generated prediction models.

13. The method for designing a prediction model according to claim 1, wherein the business dataset includes data generated by industrial production sensors and the business dataset is used by a machine learning model trained for monitoring an industrial process.

14. The method for designing a prediction model according to claim 13, wherein the industrial production sensors include:
connected objects, machine sensors, environmental sensors and/or computing probes.

15. The method for designing a prediction model according to claim 13, wherein the industrial process is selected from: an agri-food production process, a manufacturing production process, a chemical synthesis process, a packaging process or a process for monitoring an IT infrastructure.

16. The method for designing a prediction model according to claim 1, further comprising generating a representation of relationships between the variables used by a prediction model.
